(19) United States
(12) Patent Application Publication
(10) Pub. No.: US 2011/0067059 A1
(43) Pub. Date: Mar. 17, 2011

(54) MEDIA CONTROL

(75) Inventors: Michael Johnston, New York, NY (US); Hisao M. Chang, Cedar Park, TX (US); Giuseppe Di Fabbrizio, Florham Park, NJ (US); Thomas Okken, North Brunswick, NJ (US); Bernard S. Renger, New Providence, NJ (US)

(73) Assignee: AT&T INTELLECTUAL PROPERTY I, L.P., Reno, NV (US)

(21) Appl. No.: 12/644,635

(22) Filed: Dec. 22, 2009

Related U.S. Application Data
(60) Provisional application No. 61/242,737, filed on Sep. 15, 2009.

(51) Int. Cl. H04N 5/445; G10L 21/00; G06F 3/041; H04N 7/173; G06F 3/048; G06F 15/16

(52) U.S. Cl. 725/39; 704/275; 345/173; 725/87; 725/117; 725/131; 715/810; 704/E21.001; 709/219

(57) ABSTRACT

Systems and methods to control media are disclosed. A particular method includes receiving a speech input at a mobile communications device. The speech input is processed to generate audio data. The audio data is sent, via a mobile data network, to a first server. The first server processes the audio data to generate text based on the audio data. Data related to the text is received from the first server. One or more commands are sent to a second server via the mobile data network. In response to the one or more commands, the second server sends control signals based on the one or more commands to a media controller. The control signals cause the media controller to control multimedia content displayed via a display device.

### CLAIM OF PRIORITY

This application claims priority from U.S. Provisional Patent Application No. 61/242,737, filed on Sep. 15, 2009, which is incorporated herein by reference in its entirety.

### FIELD OF THE DISCLOSURE

The present disclosure is generally related to controlling media.

### BACKGROUND

With advances in television systems and related technology, an increased range and amount of content is available for users through media services, such as interactive television services, online television, cable television services, and music services. With the increased amount and variety of available content, it can be difficult or inconvenient for end users to locate specific content items using a conventional remote control device. An alternative to using a conventional remote control device is to use an interface with speech recognition that allows a user to verbally request particular content (e.g., a user may request a particular television program by stating the name of the program). However, such speech recognition approaches have often required customers to be supplied with custom hardware, such as a remote control that also includes a microphone or another type of device that includes a microphone to record the user's speech. Delivery, deployment, and reliance on the extra hardware (e.g., a remote control device with a microphone) add cost and complexity for both communication service providers and their customers.

### BRIEF DESCRIPTION OF THE DRAWINGS

FIG. 1 illustrates a block diagram of a first embodiment of a system to control media;

FIG. 2 illustrates a block diagram of a second embodiment of a system to control media using a speech mashup;

FIG. 3 illustrates a block diagram of a third embodiment of a system to control media using a speech mashup with a mobile device client;

FIG. 4 illustrates a block diagram of a fourth embodiment of a system to control media using a speech mashup with a browser-based client;

FIG. 5 illustrates components of a network associated with a speech mashup architecture to control media;

FIG. 6A illustrates a REST API request;

FIG. 6B illustrates a REST API response;

FIG. 7 illustrates a Javascript example;

FIG. 8 illustrates another Javascript example;

FIG. 9 illustrates an example of browser-based speech interaction;

FIG. 10 illustrates a flow diagram of a particular embodiment of a method of using a speech mashup;

FIG. 11A illustrates a first embodiment of a user interface for a particular application;

FIG. 11B illustrates a second embodiment of a user interface for a particular application;

FIG. 12 illustrates a diagram of a fifth embodiment of a system to control media using a speech mashup;

FIG. 13 illustrates a block diagram of a sixth embodiment of a system to control media using a speech mashup;

FIG. 14 illustrates a block diagram of a seventh embodiment of a system to control media using a speech mashup;

FIG. 15 illustrates a flow diagram of a first particular embodiment of a method of controlling media; and

FIG. 16 illustrates a flow diagram of a second particular embodiment of a method of controlling media.

### DETAILED DESCRIPTION

Systems and methods that are disclosed herein enable use of a mobile communications device, such as a cell phone or a smartphone, as a speech-enabled remote control. The mobile communications device may be used to control a media controller, such as a set-top box device or a media recorder. The mobile communications device may execute a media control application that receives speech input from a user and uses the speech input to generate control commands. For example, the mobile telephone device may receive speech input from the user and may send the speech input to a server that translates the speech input to text. Text results determined based on the speech input may be received at the mobile communications device from the server. Additionally, or in the alternative, the server sends data related to the text to the mobile communications device. For example, the server may execute a search based on the text and send results of the search to the mobile communications device. The text or the data related to the text may be displayed to the user at the mobile communications device (e.g., for confirmation or selection of a particular item). For example, the media control application may display the text to the user to confirm that the text is correct. The commands based on the text, the data related to the text, user input received at the mobile communications device, or any combination thereof, may be sent to a remote control server. The remote control server may execute control functions that control the media controller. For example, the remote control server may generate control signals that are sent to the media controller to cause particular media content, such as content specified by the speech input, to be displayed at a television or to be recorded at a media recorder. Thus, the systems and methods disclosed may enable users to use existing electronic devices, such as a smartphone or similar mobile computing or networked communication device (e.g., iPhone, BlackBerry, or PDA) as a voice-based remote control to control a display at a television, via the media controller. The systems and methods disclosed may avoid the need for additional hardware to provide a user of a set top box or a television with a special speech recognition command interface device.

Systems and methods to control media are disclosed. A particular method includes receiving a speech input at a mobile communications device. Audio data may be generated based on the speech input. For example, the speech input may be processed and encoded to generate the audio data. In another example, the speech input may be sent as raw audio data. The audio data is sent, via a mobile data network, to a first server. The first server processes the audio data to generate text based on the audio data. The data related to the text is received from the first server. One or more commands are sent to a second server via the mobile data network. In response to the one or more commands, the second server sends control signals based on the one or more commands to a media controller. The control signals may cause the media controller to control multimedia content displayed via a display device.

Another particular method includes receiving audio data from a mobile communications device at a server computing device via a mobile communications network. The audio data corresponds to speech input received at the mobile communications device. The method also includes processing the audio data to generate text and sending the data related to the text from the server computing device to the mobile communications device. The method also includes receiving one or more commands based on the data from the mobile communications device via the mobile communications network. The method further includes sending control signals based on the one or more commands to a media controller. The control signals cause the media controller to control multimedia content displayed via a display device.

A particular system includes a mobile communications device that includes one or more input devices. The one or more input devices including a microphone to receive a speech input. The mobile communications device also includes a display, a processor, and memory accessible to the processor. The memory includes processor-executable instructions that, when executed, cause the processor to generate audio data based on the speech input and to send the audio data via a mobile data network to a first server. The first server processes the plurality of audio data to generate text based on the speech input. The processor-executable instructions also cause the processor to receive the data related to the text from the first server and to generate a graphical user interface at the display based on the received data. The processor-executable instructions further cause the processor to receive input via the graphical user interface using the one or more input devices. The processor-executable instructions also cause the processor to generate one or more commands based at least partially on the received data in response to the input and to send the one or more commands to a second server via the mobile data network. In response to the one or more commands, the second server sends control signals to a media controller. The control signals cause the media controller to control multimedia content displayed via a display device.

Various embodiments are described in detail below. While specific implementations are described, it should be understood that this is done for illustration purposes only.

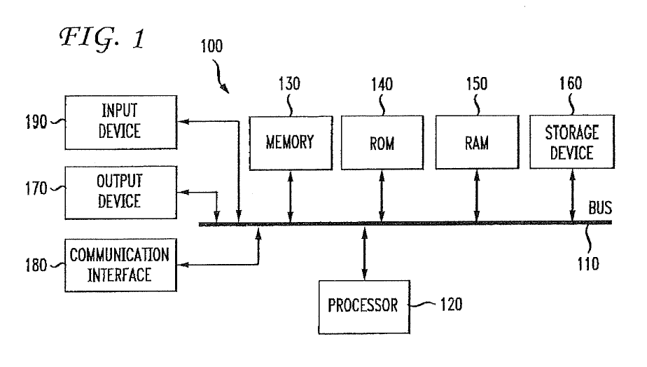

With reference to FIG. 1, an exemplary system includes a general-purpose computing device 100 including a processing unit (CPU) 120 and a system bus 110 that couples various system components including a system memory such as read only memory (ROM) 140 and random access memory (RAM) 150, to the processing unit 120. Other system memory 130 may be available for use as well. The computing device 100 may include more than one processing unit 120 or a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in the ROM 140 or the like, may provide basic routines that help to transfer information between elements within the computing device 100, such as during start-up. The computing device 100 further includes storage devices 160, such as a hard disk drive, a magnetic disk drive, an optical disk drive, tape drive, or another type of computer readable media which can store data that are accessible by a computer, such as magnetic cassettes, flash memory cards, digital versatile disks, cartridges, random access memories (RAMs) and, read only memory (ROM). The storage devices 160 may be connected to the system bus 110 by a drive interface. The storage devices 160 provide nonvolatile storage of computer readable instructions, data structures, program modules and other data for the computing device 100.

To enable user interaction with the computing device 100, an input device 190 represents any number of input mechanisms, such as a microphone for speech, a touch sensitive screen for gesture or graphical input, keyboard, mouse, motion input, and so forth. An output device 170 can include one or more of a number of output mechanisms. In some instances, multimodal systems enable a user to provide multiple types of input to communicate with the computing device 100. A communications interface 180 generally enables the computing device 100 to communicate with one or more other computing devices using various communication and network protocols.

For clarity of explanation, the computing device 100 is presented as including individual functional blocks (including functional blocks labeled as a “processor”). The functions these blocks represent may be provided through the use of either shared or dedicated hardware, including, but not limited to hardware capable of executing software. For example, the functions of the processing unit 120 presented in FIG. 1 may be provided by a single shared processor or multiple distinct processors. Illustrative embodiments may include microprocessors and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

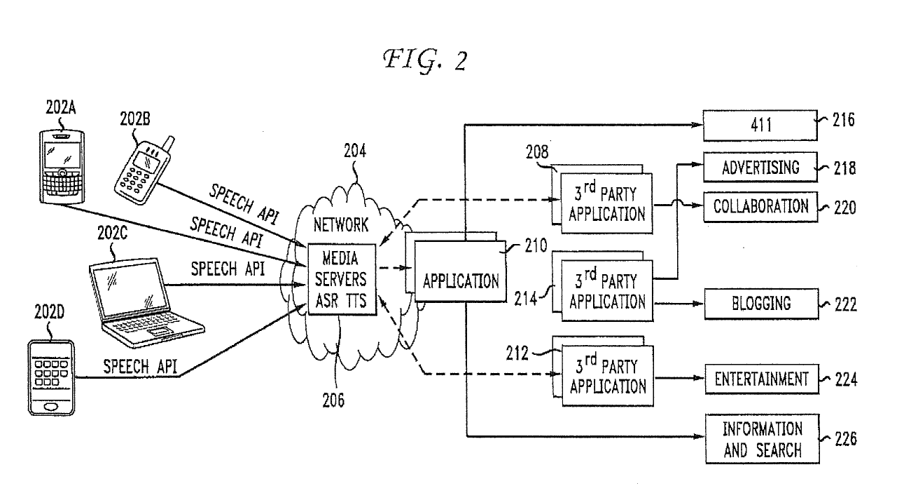

FIG. 2 illustrates a network that provides voice enabled services and application programming interfaces (APIs). Various edge devices are shown. For example, a smartphone 202A, a cell phone 202B, a laptop 202C and a portable digital assistant (PDA) 202D are shown. These are simply representative of the various types of edge devices; however, any other computing device, including a desktop computer, a tablet computer or any other type of networked device having a user interface may be used as an edge device. Each of these devices may have a speech API that is used to access a database using a particular interface to provide interoperability for distribution for voice enabled capabilities. For example, available web services may provide users with an easy and convenient way to discover and exploit new services and concepts that can be operating system independent and to enable mashups or web application hybrids.

A mashup is an application that leverages the compositional nature of public web services. For example, a mashup can be created when several data sources and services are combined or used together (i.e., “mashed up”) to create a new service. A number of technologies may be used in the mashup environment. These include Simple Object Access Protocol (SOAP), Representational State Transfer (REST), Asynchronous JavaScript and Extensible Mashup Language (XML) (AJAX), Javascript, JavaScript Object Notation (JSON) and various public web services such as Google, Yahoo, Amazon and so forth. SOAP is a protocol for exchanging XML-based messages over a network which may be done over Hypertext Transfer protocol (HTTP)/HTTP secure (HTTPS). SOAP makes use of an internet application layer protocol as a transport protocol. Both SMTP and HTTP/HTTPS are valid application layer protocols used as transport for SOAP. SOAP may enable easier communication between proxies and firewalls than other remote execution technology and it is versatile enough to allow the use of different transport protocols beyond HTTP, such as simple mail transfer protocol (SMTP) or real time streaming protocol (RTSP).

REST is a design pattern for implementing network systems. For example, a network of web pages can be viewed as a virtual state machine where the user progresses through an application by selecting links as state transitions which result in the next page which represents the next state in the application being transferred to the user and rendered for their use. Technologies associated with the use of REST include HTTP and related methods, such as GET, POST, PUT and DELETE. Other features of REST include resources that can be identified by a Uniform Resource Locator (URL) and accessible through a resource representation which can include one or more of XML/Hypertext Mashup Language (HTML), Graphic and Interchange Format (GIF), Joint Photographic Experts Group (JPEG), etc. Resource types can include text/XML, text/HTML, image/GIF, image/JPEG and so forth. Typically, the transport mechanism for REST is XML or JSON. Note that, while a strict meaning of REST may refer to a web application design in which states are represented entirely by Uniform Resource Identifier (URI) path components, such a strict meaning is not intended here. Rather, REST as used herein refers broadly to web service interfaces that are not SOAP.

In an example of the REST representation, a client browser references a web resource using a URL such as www.att.com. A representation of the resource is returned via an HTML document. The representation places the client in a new state and when the client selects a hyper link, such as index.html, it acts as another resource and the new representation places the client application into yet another state and the client application transfers state within each resource representation.

AJAX allows the user to send an HTTP request in a background mode and to dynamically update a Document Object Model, or DOM, without reloading the page. The DOM is a standard, platform-independent representation of the HTML or XML of a web page. The DOM is used by Javascript to update a webpage dynamically.

JSON involves a light weight data-interchange format. JSON is a subset of ECMA-262, 3rd Edition and could be language independent. Inasmuch as it is text-based, light weight, and easy to parse, it provides an approach for object notation.

These various technologies may be utilized in the mashup environment. Mashups which provide service and data aggregation may be done at the server level, but there is an increasing interest in providing web-based composition engines such as Yahoo! Pipes, Microsoft Popfly, and so forth. Client side mashups in which HTTP requests and responses are generated from several different web servers and “mashed up” on a client device may also be used. In some server side mashups, a single HTTP request is sent to a server which separately sends another HTTP request to a second server and receives an HTTP response from that server and “mashes up” the content. A single HTTP response is generated to the client device which can update the user interface.

Speech resources can be accessible through a REST interface or a SOAP interface without the need for any telephony technology. An application client running on one of the edge device 202A-202D may be responsible for audio capture. This may be performed through various approaches such as Java Platform, Micro Edition (JavaME) for mobile, .net, Java applets for regular browsers, Perl, Python, Java clients and so forth. Server side support may be used for sending and receiving speech packets over HTTP or another protocol. This may be a process that is similar to the realtime streaming protocol (RTSP) inasmuch as a session ID may be used to keep track of the session when needed. Client side support may be used for sending and receiving speech packets over HTTP, SMTP or other protocols. The system may use AJAX pseudo-threading in the browser or any other HTTP client technology.

Returning to FIG. 2, a network 204 includes media servers 206 which can provide advanced speech recognition (ASR) and text-to-speech (TTS) technologies. The media servers 206 represent a common, public network node that processes received speech from various client devices. The media servers 206 can communicate with various third party applications 208, 212, and 214. Another network-based application 210 may provide such services as a 411 service 216. The various applications 208, 210, 212 and 214 may involve a number of different types of services and user interfaces. Several examples are shown. These include the 411 service 216, an advertising service 218, a collaboration service 220, a blogging service 222, an entertainment service 224 and an information and search service 226.

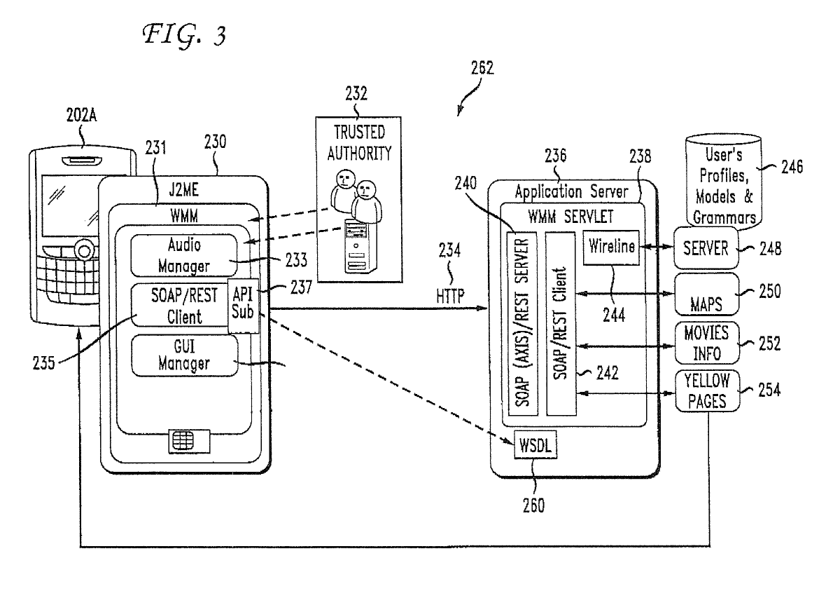

FIG. 3 illustrates a mobile context for a speech mashup architecture. The architecture 262 includes an example smartphone device 202A. This can be any mobile device by any manufacturer communicating via various wireless protocols. The various features in the smartphone device 202A include various components that include a Java Platform, Micro Edition JavaME component 230 for audio capture. A mobile client application, such as a Watson Mobile Media (WMM) application 231, may enable communication with a trusted authority 232 and may provide manual validation by a company such as AT&T, Sprint or Verizon. An audio manager 233 captures audio from the smartphone device 202A in a native coding format. A graphical user interface (GUI) Manager 239 abstracts a device graphical interface through JavaME using any graphical Java package, such as J2ME Polish and includes maps rendering and caching. A SOAP/REST client 235 and API stub 237 communicate with an ASR web service and other web applications via a network protocol, such as HTTP 234 or other protocols. On the server side, an application server 236 includes a speech mashup manager, such as a WMM servlet 238, with such features such as a SOAP (AXIS)/REST server 240 and a SOAP/REST client 242. A wireline component 244 communicates with an automatic speech recognition (ASR) server 248 that includes profiles, models and grammars 246 for converting audio into text. The ASR server 248 represents a public, common network node. The profiles, models and grammars 246 may be custom tailored for a particular user. For example, the profiles, models and grammars 246 may be trained for a particular user and periodically updated and improved. The SOAP/REST client 242 communicates with various application servers such as a maps application server 250, a movie information application server 252, and a Yellow Pages application server 254. The API stub 237 communicates with a web services description language (WSDL) file 260 which is a published web service end point descriptor such as an API XML schema. The various application servers 250, 252 and 254 may communicate data back to smartphone device 202A.

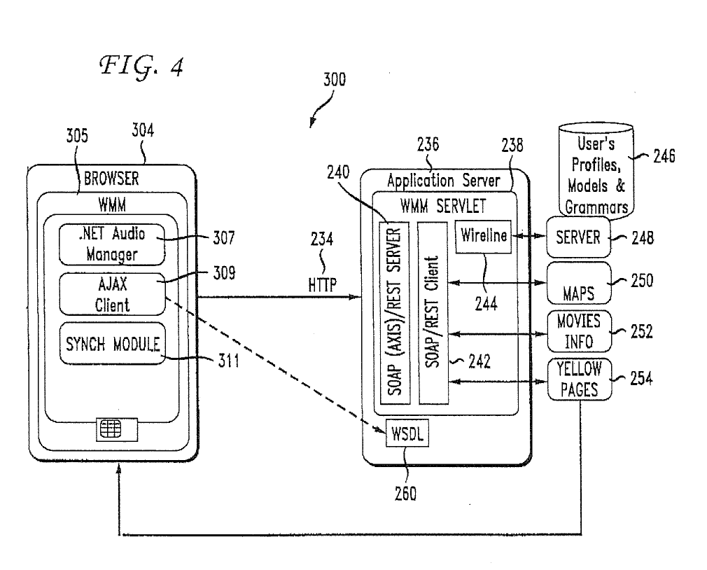

FIG. 4 illustrates a second embodiment of a speech mashup architecture. A web browser 304, which may be any browser, such as Internet Explorer or Mozilla, may include various features, such as a mobile client application (e.g., WMM 305), a .net audio manager 307 that captures audio from an audio interface, an AJAX client 309 that communicates with an ASR web service and other web applications, and a synchronization (SYNCH) module 311, such as JS Watson, that manages synchronization with the ASR web services, audio capture and a graphical user interface (GUI). Software may be used to capture and process audio. Upon the receipt of audio from the user, the AJAX client 309 uses HTTP 234 or another protocol to transmit data to an application server 236 and a speech mashup manager, such as WMM servlet 238. A SOAP (AXIS)/REST server 240 processes the HTTP request. A SOAP/REST client 242 communicates with various application servers, such as a maps application server 250, a movie information application server 252, and a Yellow Pages application server 254. A wireline component 244 communicates with an ASR server 248 that utilizes user profiles, models and grammars 246 in order to convert the audio into text. A web services description language (WSDL) file 260 is included in the application server 236 and provides information about the API XML schema to the AJAX client 309.

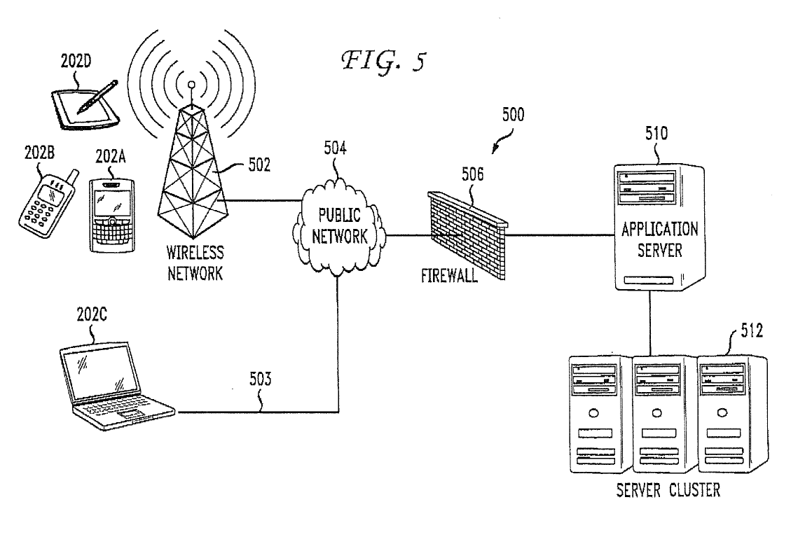

FIG. 5 illustrates physical components of a speech mashup architecture 500 according to a particular embodiment. The various edge devices 202A-D communicate either through a wireline 503 or a wireless network 502 to a public network 504, the Internet, or another communication network. A firewall 506 may be placed between the public network 504 and an application server 510. A server cluster 512 may be used to process incoming speech.

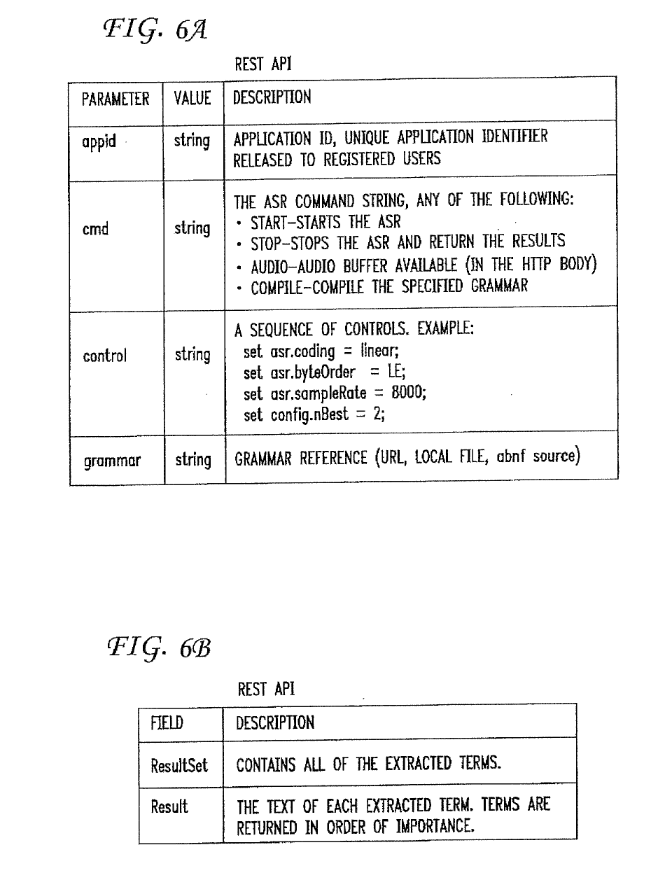

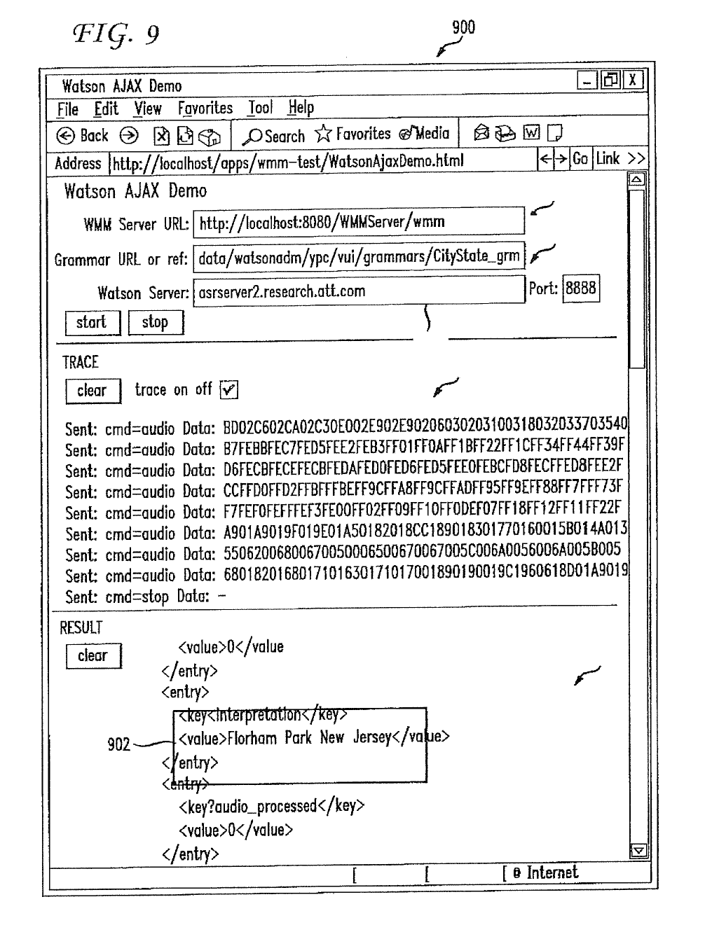

FIG. 6A illustrates REST API request parameters and associated descriptions. Various parameter subsets illustrated in FIG. 6A may enable speech processing in a user interface. For example, a cmd parameter is described as including the concept that an ASR command string may provide a start indication to start automatic speech recognition and a stop indication to stop automatic speech recognition and return the results, as is further illustrated in FIG. 9. Command strings in the REST API request may control use of a buffer and compilation or application of various grammars. Other control strings include data to control a byte order, coding, sampling rate, n-best results and so forth. If a particular control code is not included, default values may be used. The REST API request can also include other features such as a grammar parameter to identify a particular grammar reference that can be associated with a user or a particular domain and so forth. For example, the REST API request may include a grammar parameter that identifies a particular grammar for use in a travel industry context, a media control context, a directory assistance context and so forth. Furthermore, the REST API request may provide a parameter identifying a particular grammar associated with a particular user that is selected from a group of grammars. For example, the particular grammar may be selected to provide high quality speech recognition for the particular user. Other REST API request parameters can be location-based. For example, using a location based service, a particular mobile device may be found at a particular location, and the REST API may automatically insert the particular parameter that may be associated with a particular location. This may cause a modification or the selection of a particular grammar for use in the speech recognition

To illustrate, the REST API may combine information about a current location of a tourist, such as Gettysburg, with home location information of the tourist, such as Texas. The REST API may select an appropriate grammar based on what the system is likely to encounter when interfacing with individuals from Texas visiting Gettysburg. For example, the REST API may select a regional grammar associated with Texas, or may select a grammar to anticipate a likely vocabulary for tourists at Gettysburg, taking into account prominent attractions, commonly asked questions, or other words or phrases. The REST API can automatically select the particular grammar based on available information. The REST API may present its best guess for the grammar to the user for confirmation, or the system can offer a list of grammars to the user for a selection of the one that is most appropriate.

FIG. 6B illustrates an example REST API response that includes a result set field that includes all of the extracted terms and a Result field that includes the text of each extracted term. Terms may be returned in the result field in order of importance.

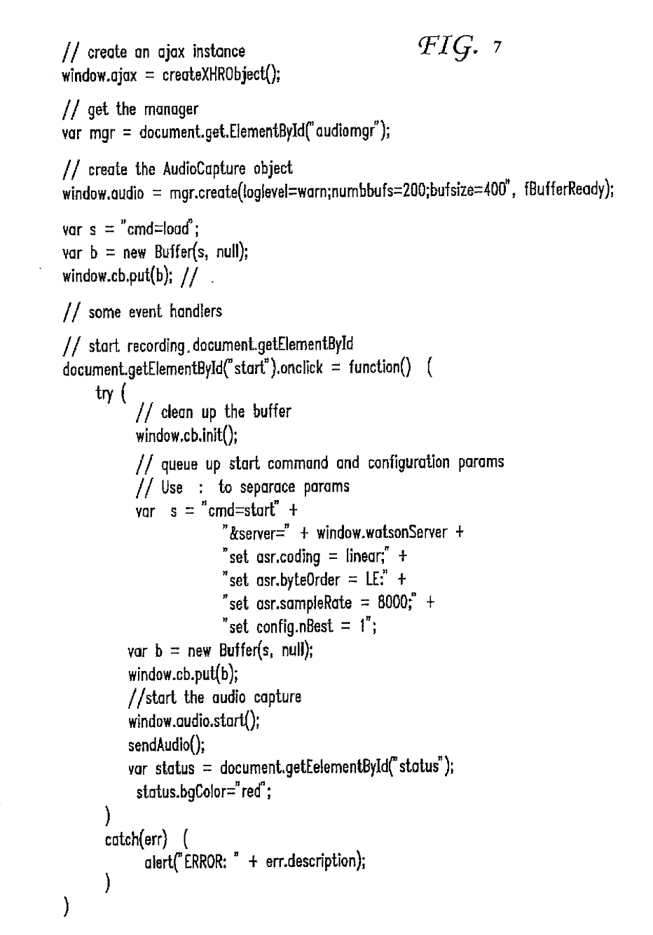

FIG. 7 illustrates a first example of pseudocode that may be used in a particular embodiment. The pseudocode illustrates JavaScript code for use with an Internet Explorer browser application. This example and other pseudocode examples that are described herein may be modified for use with other types of user interfaces or other browser applications. The example illustrated in FIG. 7 creates an audio capture object, sends initial parameters, and begins audio capture.

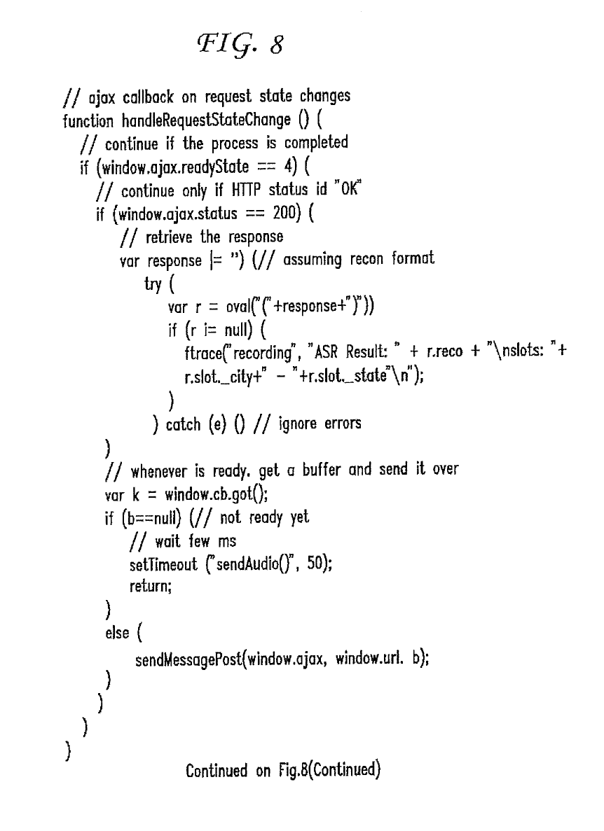

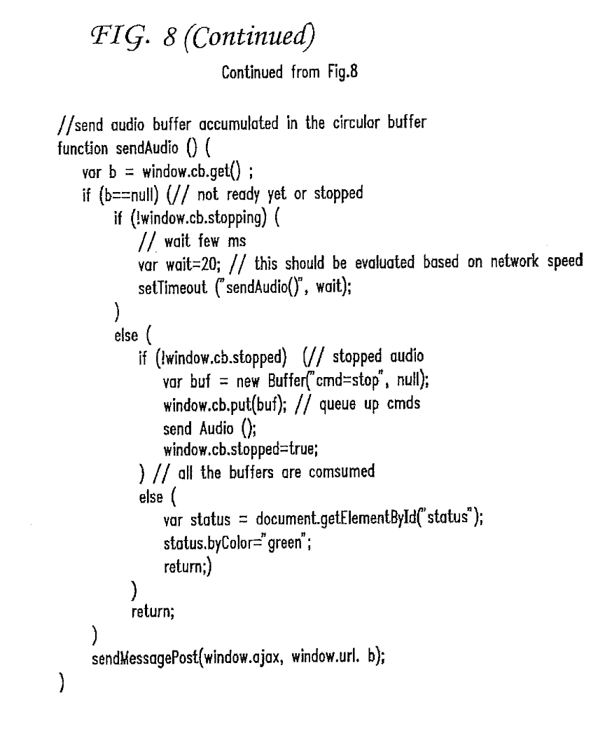

FIG. 8 illustrates a second example of pseudocode that may be used in a particular embodiment. The pseudocode illustrates JavaScript code for use with an Internet Explorer browser application. This example provides for pseudo-threading and sending audio buffers.

FIG. 9 illustrates a user interface display window 900 according to a particular embodiment. The user interface display window 900 illustrates return of text in response to audio input. In the illustrated example, a user provided the audio input (i.e., speech) “Florham Park, N.J.” The audio input was interpreted via an automatic speech recognition server at a common, public network node and the words “Florham Park, N.J.” 902 were returned as text. The user interface display window 900 includes a field 904 including information pointing to a public speech mashup manager server (i.e., via a URL). The user interface display window 900 also includes a field 906 that specifies a grammar URL to indicate a grammar to be used. The grammar URL points to a network location of a grammar that a speech recognizer can use in speech recognition. The user interface display window 900 also includes a field 908 that identifies a Watson Server, which is a voice processing server. Shown in a center section 910 of the user interface display window 900 is data corresponding to the audio input, and in a lower section 912, an example of the returned result for speech recognition is shown.

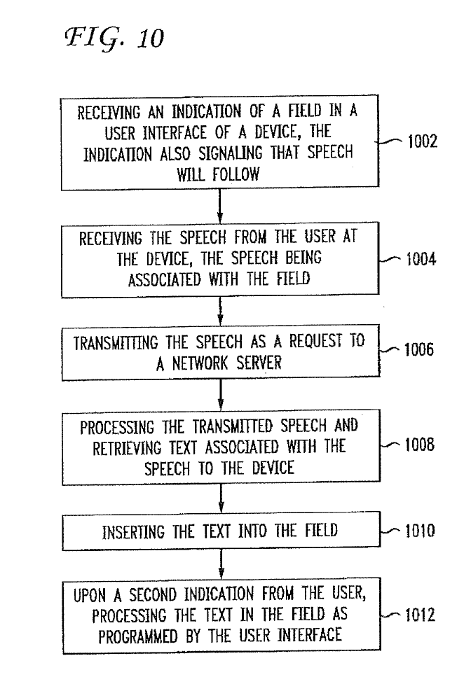

FIG. 10 illustrates a flow diagram of a first particular embodiment of a method to process speech input. The method may enable speech processing via a user interface of a device. Although the method may be used for various speech processing tasks, the method discussed here is a particular illustrative context to simplify the discussion. In particular, the method is discussed in the context of speech input used to access a map application in which a user can provide an address and receive back a map indicating how to get to a particular location. The method includes, at 1002, receiving indication of selection of a field in a user interface of a device. The indication also signals that speech will follow and that the speech is associated with the field (i.e., as speech input related to the field). The method also includes, at 1004, receiving the speech from the user at the device. The method also includes, at 1006, transmitting the speech as a request to a public, common network node that receives speech. The request may include at least one standardized parameter to control a speech recognizer in the public, common network node.

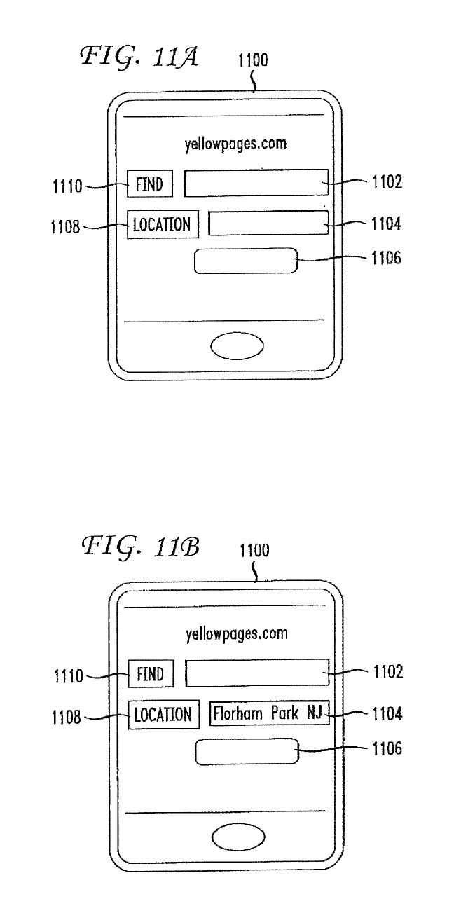

To illustrate, referring to FIG. 11A, a user interface 1100 of a mobile device is illustrated. The mobile device may be adapted to access a voice enabled application using a network based speech recognizer. The network based speech recognizer may be interfaced directly with a map application mobile web site (indicated in FIG. 11A as “yellowpages.com”). The user interface 1100 may include several fields, including a find field 1102 and a location field 1104. A search button 1106 may be selectable by a user to process a request after the find field 1102, the location field 1104, or both, are populated. The user may select a location button 1108 to provide an indication of selection of the location field 1104 in the user interface 1100. The user may select a find button 1110 to provide an indication of selection of the find field 1102 in the user interface 1100. The indication of selection of a field may also signal that the user is about to speak (i.e., to provide speech input). The user may provide location information via speech, such as by stating “Florham Park, N.J.”. The user may select the location button 1108 again as an end indication to indicate an end of the speech input associated with the location field 1104. In other embodiments, other types of end indication may be used, such as a button click, a speech code (e.g., “end”), or a multimodal input that indicates that the speech intended for the field has ceased. The ending indication may notify the system that the speech input associated with the location field 1104 has ceased. The speech input may be transmitted to a network based server for processing.

Returning to FIG. 10, the method includes, at 1008, processing the transmitted speech at the public, common network node. The device (that is, the device used by the user to provide the speech input) receives text associated with the speech at the device and, at 1010, inserts the text into the field. Optionally, the user may provide a second indication, at 1012, notifying the system to start processing the text in the field as programmed by the user interface.

FIG. 11B illustrates the user interface 1100 of FIG. 11A after the user has selected the location button 1108, provided the speech input “Florham Park, N.J.” and selected the location button 1108 again. A network based speech processor has returned the text “Florham Park, N.J.” in response to the speech input and the device has inserted the text into the location field 1104 in the user interface 1100. The user may select the search button 1106 to submit a search request to search for locations associated with the text in the location field 1104. The search request may be processed in a conventional fashion according to the programming of the user interface 1100. Thus, after the speech input is provided and text corresponding to the speech input is returned and inserted in the user interface 1100, other processing associated with the text may occur as though the user had typed the text into the user interface 1100. As has been described above, transmitting the speech input to the network server and returning text may be performed by one of a REST or SOAP interface (or any other web-based protocol) and may be transmitted using an HTTP, SMTP, a protocol similar to Real Time Messaging Protocol (RTMP) or some other known protocol such as media resource control protocol (MRCP), session initiation protocol (SIP), transmission control protocol (TCP)/internet protocol (IP), etc. or a protocol developed in the future.

Speech input may be provided for any field and at any point during processing of a request or other interaction with the user interface 1100. For example, FIG. 11B further illustrates that after text is inserted into the location field 1104 based on a first speech input, the user may select a second field indicating that speech input is to be provided for the second field, such as the find field 1102. As illustrated in FIG. 11B, the user has provided “Restaurants” as the second speech input. The user has indicated an end of the second speech input and the second speech input has be sent to the network server which returned the text “Restaurants”. The returned text has been inserted into the find field 1102. Accordingly, the user may select the search button 1106 to generate a search request for restaurants in Florham Park, N.J.

In a particular embodiment, after the text based on speech input is received from the network server, the text is inserted into the appropriate field 1102, 1104. The user may thus review the text to ensure that the speech input has been processed correctly and that the text is correct. When the user is satisfied with the text, the user may provide an indication to process the text, e.g., by selecting the search button 1106. In another embodiment, the network server may send an indication (e.g., a command) with the text generated based on the speech input. The indication from the network server may cause the user interface 1100 to process the text without further user input. In an illustrative embodiment, the network server sends the indication that causes the user interface to process the text without further user input when the speech processing satisfies a confidence threshold. For example, a speech recognizer of the network server may determine a confidence level associated with the text. When confidence level satisfies the confidence threshold the text may be automatically processed without further user input. To illustrate, when the speech recognizer has at least 90% confidence that the speech was recognized correctly, the network server may transmit an instruction with the recognized text to perform a search operation associated with selecting the search button 1106. A notification may be provided to the user to notify the user that the search operation is being performed and that the user does not need to do anything further but to view the results of the search operation. The notification may be audible, visual or a combination of cues indicating that the operation is being performed for the user. Automatic processing based on the confidence level may be a feature that can be enabled or disabled depending on the application.

In another embodiment, the user interface 1100 may present an action button, such as the search button 1106, to implement an operation only when the confidence level fails to satisfy the threshold. For example, the returned text may be inserted into the appropriate field 1102, 1104 and then processed without further user input when the confidence threshold is satisfied and the search button 1106 illustrated in FIGS. 11A and 11B may be replaced with information indicating that automatic processing is being performed, such as “Searching for Restaurants . . . .” However, when the confidence threshold is not satisfied, the user interface 1100 may insert the returned text into the appropriate field 1102, 1104 and display the search button 1106 to give the user an opportunity to review the returned text before initiating the search operation.

In another embodiment, the speech recognizer may return two or more possible interpretations of the speech as multiple text results. The user interface 1100 may display each possible interpretation in a separate text field and present both fields to the user with an indication instructing the user to select which text field to process. For example, a separate search button may be presented next to separate text field in the user interface 1100. The user can then view both simultaneously and only needs to enter a single action, e.g., selecting the appropriate search button, to process the request.

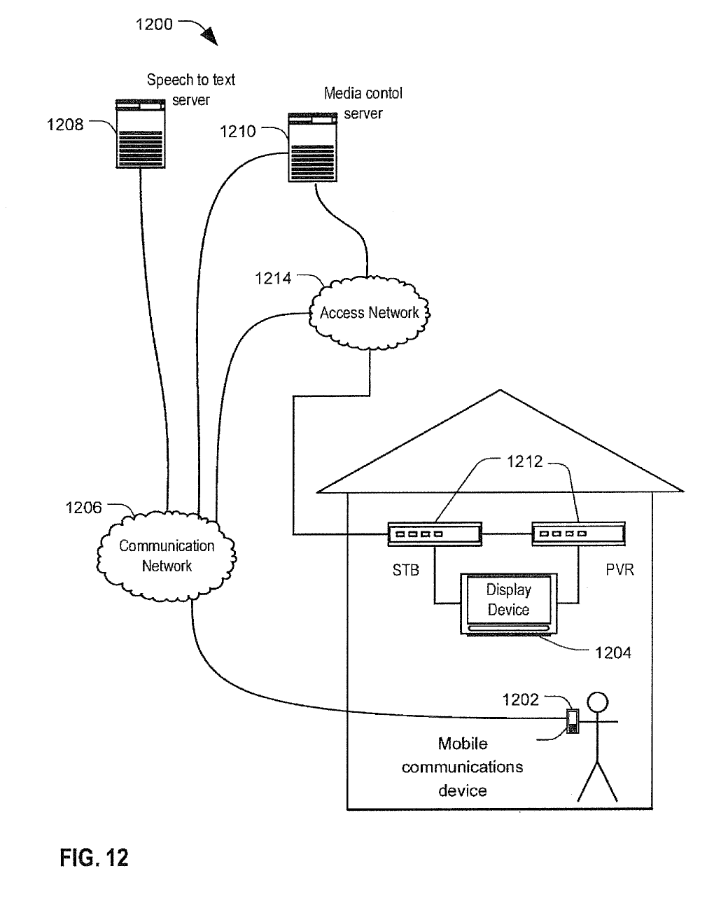

Referring to FIG. 12, a particular embodiment of a system 1200 to control media using a speech mashup is illustrated. The system 1200 enables use of a mobile communications device 1202 to control media, such as video content, audio content, or both, presented at a display device 1204 separate from the mobile communications device 1202. Control commands to control the media may be generated based on speech input received from a user. For example, the user may speak a voice command, such as a direction to perform a search of electronic program guide data, a direction to change a channel displayed at the display device 1204, a direction to record a program, and so forth, into the mobile communications device 1202. The mobile communications device 1202 may be executing an application that enables the mobile communications device 1202 to capture the speech input and to convert the speech input into audio data. The audio data may be sent, via a communication network 1206, such as a mobile data network, to a speech to text server 1208. The speech to text server 1208 may select an appropriate grammar for converting the speech input to text. For example, the mobile communications device 1202 may send additional data with the audio data that enables the speech to text server 1208 to select the appropriate grammar. In another example, the mobile communications device 1202 may be associated with a subscriber account and the speech to text server 1208 may select the appropriate grammar based on information associated with the subscriber account. To illustrate, additional data sent with the audio data may indicate that the speech input was received via the application, which may be a media control application. Accordingly, the speech to text server 1208 may select a media controller grammar. In a particular embodiment, the speech to text server 1208 is an automatic speech recognition (ASR) server, such as the media server 206 of FIG. 2, the ASR server 248 of FIGS. 3 and 4. For example, the speech to text server 1208 and the mobile communications device 1202 may communicate via a REST or SOAP interface (or any other web interface) and an HTTP, SMTP, a protocol similar to Real Time Messaging Protocol (RTMP) or some other known network protocol such as MRCP, SIP, TCP/IP, etc. or a protocol developed in the future.

The speech to text server 1208 may convert the audio data into text. The speech to text server 1208 may send data related to the text back to the mobile communications device 1202. The data related to the text may include the text or results of an action performed by the speech to text server 1208 based on the text. For example, the speech to text server 1208 may perform a search of media content (e.g., electronic program guide data, video on demand program data, and so forth) to identify media content items related to the text and search results may be returned to the mobile communications device. The mobile communications device 1202 may generate a graphical user interface (GUI) based on the data received from the speech to text server 1208. For example, the mobile communications device 1202 may display the text to the user to confirm that the speech to text conversion generated appropriate text. If the text is correct, the user may provide input confirming the text. The user may also provide additional input via the mobile communications device 1202, such as input selecting particular search options or input rejecting the text and providing new speech input for translation to text. In another example, the GUI may include one or more user selectable options based on the data received from the speech to text server 1208. To illustrate, when the speech input may be converted to more than one possible text (i.e., there is uncertainty as to the content or meaning of the speech input), the user selectable options may present the possible texts to the user for selection of an intended text. In another illustration, where the speech to text server 1208 performs a search based on the text, the user selectable options may include selectable search results that the user may select to take an additional action (such as to record or view a particular media content item from the search results.

After the user has confirmed the text, provided other input, or selected a user selectable option, the mobile communications device 1202 may send one or more commands to a media control server 1210. In a particular embodiment, when a confidence level associated with the data received from the speech to text server 1208 satisfies a threshold, the mobile communications device 1202 may send the one or more commands without additional user interaction. For example, when the speech input is converted to the text with a sufficiently high confidence level, the mobile communications device 1202 may act on the data received from the speech to text server without waiting for the user to confirm the text. In another example, when the speech to text conversion satisfies a threshold and there is a sufficiently high confidence level that a particular search result was intended, the mobile communications device 1202 may take an action related to that search result without waiting for the user to select the search result. In a particular embodiment, the speech to text server 1208 determines the confidence level associated with the conversion of the speech input to the text. The confidence level related to whether a particular search result was intended may be determined by the speech to text server 1208, a search server (not shown) or the mobile communications device 1202. For example, the mobile communications device 1202 may include a memory that stores user historical information. The mobile communications device 1202 may compare search results returned by the speech to text server 1208 to the user historical data to identity a media content item that was intended by the user based on the user historical data.

The mobile communications device 1202 may generate one or more commands based on the text, based on the data received from the speech to text server 1208, based on the other input provided by the user at the mobile communications device, or any combination thereof. The one or more commands may include directions for actions to be taken at the media control server 1210, at a media control device 1212 in communication with the media control server 1210, or both. For example, the one or more commands may instruct the media control server 1210, the media control device 1212, or any combination thereof, to perform a search of electronic program guide data for a particular program described via the speech input. In another example, the one or more commands may instruct the media control server 1210, the media control device 1212, or any combination thereof to record, download, display or otherwise access a particular media content item.

In a particular embodiment, in response to the one or more commands, the media control server 1210 sends control signals to the media control device 1212, such as a set-top box device or a media recorder (e.g., a personal video recorder). The control signals may cause the media control device 1212 to display a particular program, to schedule a program for recording, or to otherwise control presentation of media at the display device 1204, which may be coupled to the media control device 1212. In another particular embodiment, the mobile communications device 1202 sends the one or more commands to the media control device 1212 via a local communication, e.g., a local area network or a direct communication link between the mobile communications device 1202 and the media control device 1212. For example, the mobile communications device 1202 may communicate commands to the media control device 1212 via wireless communications, such as infrared signals, Bluetooth communications, another radiofrequency communications (e.g., Wi-Fi communications), or any combination thereof.

In a particular embodiment, the media control server 1210 is in communication with a plurality of media control devices via a private access network 1214, such as an Internet protocol television (IPTV) system, a cable television system or a satellite television system. The plurality of media control devices may include media control devices located at more than one subscriber residence. Accordingly, the media control server 1210 may select a particular media control device to which to send the control signals, based on identification information associated with the mobile communications device 1202. For example, the media control server 1210 may search subscriber account information based on the identification information associated with the mobile communications device 1202 to identify the particular media control device 1212 to be controlled based on the commands received from the mobile communications device 1202.

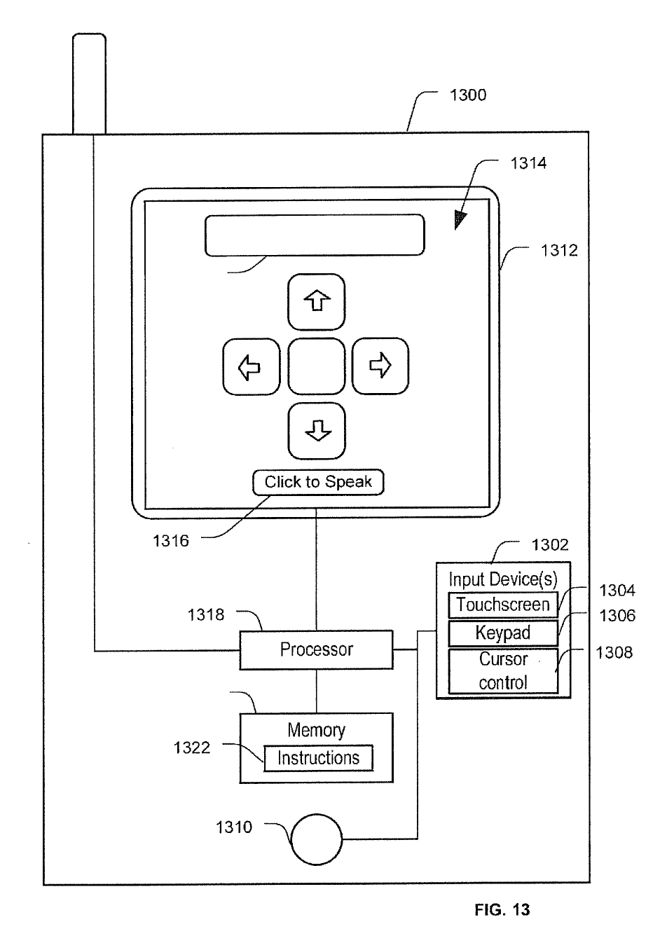

Referring to FIG. 13, a particular embodiment of a mobile communications device 1300 is illustrated. The mobile communications device 1300 may include one or more input devices 1302. The one or more input devices 1302 may include one or more touch-based input devices, such as a touch screen 1304, a keypad 1306, a cursor control device 1308 (e.g., a trackball), other input devices, or any combination thereof. The mobile communications device 1300 may also include a microphone 1310 to receive a speech input.

The mobile communications device 1300 may also include a display 1312 to display output, such as a graphical user interface 1314, one or more soft buttons or other user selectable options. For example, the graphical user interface 1314 may include a user selectable option 1316 that is selectable by a user to provide speech input.

The mobile communications device 1300 may also include a processor 1318 and a memory 1320 accessible to the processor 1318. The memory 1320 may include processor-executable instructions 1322 that, when executed, cause the processor 1318 to generate audio data based on speech input received via the microphone 1310. The processor-executable instructions 1322 may also be executable by the processor 1318 to send the audio data, via a mobile data network, to a server. The server may process the audio data to generate text based on the audio data.

The processor-executable instructions 1322 may also be executable by the processor 1318 to receive data related to the text from the server. The data related to the text may include the text itself, results of an action performed by the server based on the text (e.g., search results based on a search performed using the text), or any combination thereof. The data related to the text may be sent to the display 1312 for presentation. For example, the data related to the text may be inserted into a text box 1324 of the graphical user interface 1314. The processor-executable instructions 1322 may also be executable by the processor 1318 to receive input via the one or more input devices 1302. For example, the input may be provided by a user to confirm that the text displayed in the text box 1324 is correct. In another example, the input may be to select one or more user selectable options based on the data related to the text. To illustrate, the user selectable options may include various possible text translations of the speech input, selectable search results, user selectable options to perform actions based on the data related to the text, or any combination thereof. The processor-executable instructions 1322 may also be executable by the processor 1318 to generate one or more commands based at least partially on the data related to the text. The processor-executable instructions 1322 may also be executable by the processor 1318 to send the one or more commands to a server (which may be the same server that processed the speech input or another server) via the mobile data network. In response to the one or more commands, the server may send control signals to a media controller. The control signals may cause the media controller to control multimedia content displayed via a display device separate from the mobile communications device 1300.

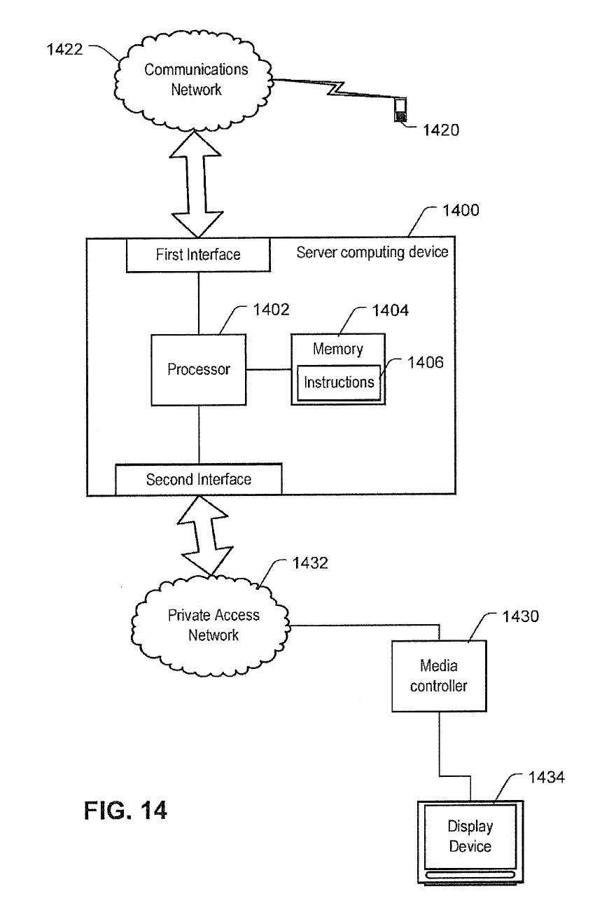

Referring to FIG. 14, a particular embodiment of a system to control media is illustrated. The system includes a server computing device 1400 that includes a processor 1402 and memory 1404 accessible to the processor 1402. The memory 1404 may include processor-executable instructions 1406 that, when executed, cause the processor 1402 to receive audio data from a mobile communications device 1420 via a communications network 1422, such as a mobile data network. The audio data may correspond to speech input received at the mobile communications device 1420.

The processor-executable instructions 1408 may also be executable by the processor 1402 to generate text based on the speech input. The processor-executable instructions 1408 may further be executable by the processor 1402 to take an action based on the text. For example, the processor 1402 may generate a search query based on the text and send the search query to a search engine (not shown). In another example, the processor 1402 may generate a control signal based on the text and send the control signal to a media controller to control media presented via the media controller. The server computing device 1400 may send data related to the text to the mobile communications device 1420. For example, the data related to the text may include the text itself, search results related to the text, user selectable options related to the text, other data accessed or generated by the server computing device 1400 based on the text, or any combination thereof.

The processor-executable instructions 1408 may also be executable by the processor 1402 to receive one or more commands from the mobile communications device 1420 via the communications network 1422. The processor-executable instructions 1408 may further be executable by the processor 1402 to send control signals based on the one or more commands to the media controller 1430, such as a set top box. For example, the control signals may be sent via a private access network 1432 (such as an Internet Protocol Television (IPTV) access network) to the media controller 1430. The control signals may cause the media controller 1430 to control display of multimedia content at a display device 1434 coupled to the media controller 1430.

In a particular embodiment, the server computing device 1400 includes a plurality of computing devices. For example, a first computing device may provide speech to text translation based on the audio data received from the mobile communications device 1420 and a second computing device may receive the one or more commands from the mobile communications device 1420 and generate the control signals for the media controller 1430. To illustrate, the first computing device may include an automatic speech recognition (ASR) server, such as the media server 206 of FIG. 2 or the ASR server 248 of FIGS. 3 and 4, and the second computing device may include an application server, such as the application server 210 of FIG. 2, or one of the servers 250, 252, 254 provided by application servers of FIGS. 3 and 4.

In a particular embodiment, the disclosed system enables use of the mobile communications device 1420 (e.g., a cell phone or a smartphone) as a speech-enabled remote control in conjunction with a media device, such as the media controller 1430. In a particular illustrative embodiment, the mobile communications device 1420 presents a user with a click to speak button, a feedback window, and navigation controls in a browser or other application running on the mobile communications device 1420. Speech input provided by the user via the mobile communications device 1420 is sent to the server computer device 1400 for translation to text. Text results determined based on the speech input, search results based on the text, or other data related to the text are received at the mobile communications device 1420. The speech input may be relayed to the media controller 1430, e.g., by use of the HTTP protocol. A remote control server (such as the server computing device 1400) may be used as a bridge from the HTTP session running on the mobile communications device 1420 and an HTTP session running on the media controller 1430.

The system may enable users to use existing electronic devices, such as a smartphone or similar mobile computing or communication device (e.g., iPhone, BlackBerry, or PDA) as a voice-based remote control to control a display at the display device 1434, such as a television, via the media controller 1430 (e.g., a set top box). The system avoids the need for additional hardware to provide a user of a set top box or a television with a special speech recognition command interface device. A remote application executing on the mobile communications device 1420 communicates with the server computing device 1400 via the communications network 1422 to perform speech recognition (e.g., speech to text conversion). The results of the speech recognition (e.g., text of “American idol show tonight” derived from user speech input at the mobile communications device 1420) may be relayed from the mobile communications device 1420 to an application at the media controller 1430, where the results may be used by the application at the media controller 1430 to execute a search or other set top box command. In a particular example, a string is recognized and is communicated over HTTP to the server computing device 1400 (acting as a remote control server) via the internet or another network. The remote control server relays a message that includes the recognized string to the media controller 1430, so that a search can be executed or another action can be performed at the media controller 1430. Additionally, pressing navigation buttons and other controls on the mobile communications device 1420 may result in messages being relayed from the mobile communications device 1420 through the remote control server to the media controller 1430 or sent to the media controller via a local communication (e.g., a local Wi-Fi network).

Particular embodiments may avoid cost of a specialized remote control device and may enable deployment of speech recognition service offerings to users without changing their television remote. Since many mobile phones and other mobile devices have a graphical display, the display can be used to provide local feedback to the user regarding what they have said and the text determined based on their speech input. If the mobile communications device has a touch screen, the mobile communications device may present a customizable or reconfigurable button layout to the user to enable additional controls. Another benefit is that different individual users, each having their own mobile communications device, can control a television or other display coupled to the media controller 1430, addressing problems associated with trying to find a lost remote control for the television or the media controller 1430.

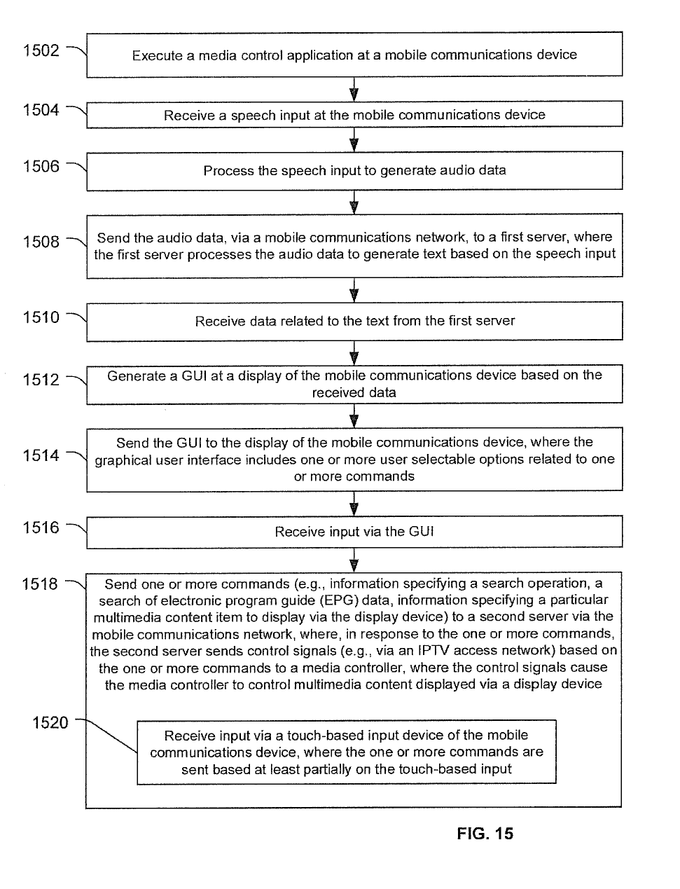

Referring to FIG. 15, a flow diagram of a particular embodiment of a method of controlling media is shown. The method may include, at 1502, executing a media control application at a mobile communications device, such as a mobile communications device. For example, the mobile communications device may include one of the edge devices 202A, 202B, 202C and 202D of FIGS. 2, 3 and 5. The media control application may be adapted to generate commands based on input received at the mobile communications device, based on data received from a remote server (such as a speech to text sever), or any combination thereof. The method also includes, at 1504, receiving a speech input at a mobile communications device. The speech input may be processed, at 1506, to generate audio data.

The method may further include, at 1508, sending the audio data via a mobile communications network to a first server. The first server may process the audio data to generate text based on the speech input. The first server may also take one or more actions based on the text, such as performing a search related to the text. The data related to the text may be received at the mobile communications device, at 1510, from the first server. The method may include, at 1512, generating a graphical user interface (GUI) at a display of the mobile communications device based on the received data. The GUI may be sent to the display, at 1514. The GUI may include one or more user selectable options. For example, the one or more user selectable options may relate to one or more commands to be generated based on the text or based on the data related to the text, selection of particular options (e.g., search options) related to the text or the data related to the text, input of additional speech input, confirmation of the text or the data related to the text, other features or any combination thereof. Input may be received from the user at the mobile communications device via the GUI, at 1516.

The method may also include, at 1518, sending one or more commands to a second server via the mobile data network. The one or more commands may include information specifying an action, such as a search operation, based on the text or based on the data related to the text. For example, the search operation may include a search of electronic program guide (EPG) data to identify one or more media content items that are associated with search terms specified in the text. The one or more commands may include information specifying a particular multimedia content item to display via the display device. For example, the multimedia content item may be selected from an electronic program guide based on the text or based on the data related to the text. The particular multimedia content item may include at least one of a video-on-demand content item, a pay-per-view content item, a television programming content item, and a pre-recorded multimedia content item accessible by the media controller. The one or more commands may include information specifying a particular multimedia content item to record at a media recorder accessible by the media controller.

The method may also include receiving input via a touch-based input device of the mobile communications device, at 1520. The one or more commands may be sent based at least partially on the touch-based input. The touch-based input device may include a touch screen, a soft key, a keypad, a cursor control device, another input device, or any combination thereof. For example, at 1514, the graphical user interface sent to the display of the mobile communications device may include one or more user selectable options related to the one or more commands. The one or more commands may include information specifying a particular multimedia content item to record at a media recorder accessible by the media controller. For example, the one or more user selectable options may include options to select from a set of available choices related to the speech input. To illustrate, where the speech input is “comedy programs” and the speech input is used to initiate a search of electronic program guide data, the one or more user selectable options may list comedy programs that are identified based on the search. The user may select one or more of the comedy programs via the one or more user selectable options for display or recording.

The first server and the second server may be the same server or different servers. In response to the one or more commands, the second server may send control signals based on the one or more commands to a media controller. The control signals may cause the media controller to control multimedia content displayed via a display device coupled to the media controller. In a particular embodiment, the second server sends the control signals to the media controller via a private access network. For example, the private access network may be an Internet Protocol Television (IPTV) access network, a cable television access network, a satellite television access network, another media distribution network, or any combination thereof. In another particular embodiment, the media controller is the second server. Thus, the mobile communications device may send the one or more commands to the media controller directly (e.g., via infrared signals or a local area network).

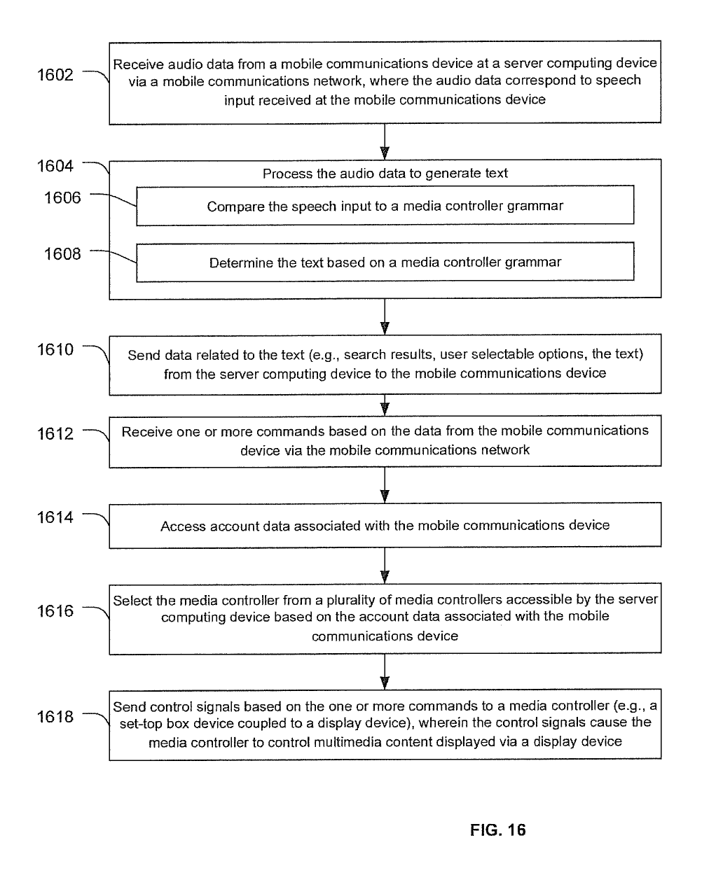

Referring to FIG. 16, a flow diagram of a particular embodiment of a method to control media is shown. The method may include, at 1602, receiving audio data from a mobile communications device at a server computing device via a mobile communications network. The audio data may be received from the mobile communications device via hypertext transfer protocol (HTTP). The audio data may correspond to speech input received at the mobile communications device. The method also includes, at 1604, processing the audio data to generate text. For example, processing the audio data may include, at 1606, comparing the speech input to a media controller grammar associated with the media controller, the mobile communications device, an application executing at the mobile communications device, a user, or any combination thereof, and determining the text based on the grammar and the audio data, at 1608.

The method may also include performing one or more actions related to the text, such as a search operation and, at 1610, sending the data related to the text from the server computing device to the mobile communications device. One or more commands based on the data related to the text may be received from the mobile communications device via the mobile communications network, at 1612. In a particular embodiment, account data associated with the mobile communications device is accessed, at 1614. For example, a subscriber account associated with the mobile communications device may be accessed. The media controller may be selected from a plurality of media controllers accessible by the server computing device based on the account data associated with the mobile communications device, at 1616.

The method may also include, at 1618, sending control signals based on the one or more commands to the media controller. The control signals may cause the media controller to control multimedia content displayed via a display device. In a particular embodiment, the media controller may include a set-top box device coupled to the display device. The control signals may be sent to the media controller via hypertext transfer protocol (HTTP).

Embodiments disclosed herein may also include computer-readable storage media for carrying or having computer-executable instructions or data structures stored thereon. Such computer-readable storage media can be any available tangible media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to store program code in the form of computer-executable instructions or data structures.

Computer-executable and processor-executable instructions include, for example, instructions and data that cause a general purpose computer, special purpose computer, or special purpose processing device to perform a certain function or group of functions. Computer-executable and processor-executable instructions also include program modules that are executed by computers in stand-alone or network environments. Generally, program modules include routines, programs, objects, components, and data structures, etc. that perform particular tasks or implement particular data types. Computer-executable and processor-executable instructions, associated data structures, and program modules represent examples of the program code for executing the methods disclosed herein. The particular sequence of such executable instructions or associated data structures represents examples of corresponding acts for implementing the functions described in the methods. Program modules may also include any tangible computer-readable storage medium in connection with the various hardware computer components disclosed herein, when operating to perform a particular function based on the instructions of the program contained in the medium.

Embodiments disclosed herein may be practiced in network computing environments with many types of computer system configurations, including personal computers, hand-held devices, multi-processor systems, microprocessor-based or programmable consumer electronics, network PCs, minicomputers, mainframe computers, tablet computer and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, SIP, RTCP, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the drawings are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method, comprising:
receiving a speech input at a mobile communications device;
processing the speech input to generate audio data;
sending the audio data, via a mobile data network, to a first server, wherein the first server processes the audio data to generate text based on the audio data;
receiving data related to the text from the first server; and
sending one or more commands to a second server via the mobile data network, wherein, in response to the one or more commands, the second server sends control signals based on the one or more commands to a media controller, wherein the control signals cause the media controller to control multimedia content displayed via a display device.

2. The method of claim 1, wherein the one or more commands include information specifying a search operation based on the text.

3. The method of claim 1, wherein the received data includes results of a search of electronic program guide (EPG) data to identify one or more media content items that are associated with search terms specified in the text.

4. The method of claim 1, further comprising receiving input via a touch-based input device of the mobile communications device, wherein the one or more commands are sent based at least partially on the touch-based input.

5. The method of claim 1, further comprising sending a graphical user interface with the received data to a display of the mobile communications device, wherein the graphical user interface includes one or more user selectable options related to the one or more commands.

6. The method of claim 1, wherein the one or more commands include information specifying a particular multimedia content item to display via the display device.

7. The method of claim 6, wherein the particular multimedia content item includes at least one of a video-on-demand content item, a pay-per-view content item, a television programming content item, and a pre-recorded multimedia content item accessible by the media controller.

8. The method of claim 1, wherein the one or more commands include information specifying a particular multimedia content item to record at a media recorder accessible by the media controller.

9. The method of claim 1, wherein the second server sends the control signals to the media controller via a private access network.

10. The method of claim 9, wherein the private access network comprises an Internet Protocol Television (IPTV) access network.

11. The method of claim 1, further comprising executing a media control application at the mobile communications device before receiving the speech input, wherein the media control application is adapted to generate the one or more commands based on the received data and based on additional input received at the mobile communications device.

12. The method of claim 1, further comprising:
sending the text to a display of the mobile communications device; and
receiving input confirming the text at the mobile communications device before sending the one or more commands.

13. The method of claim 1, wherein the first server and second server are the same server.

14. A method, comprising:
receiving audio data from a mobile communications device at a server computing device via a mobile communications network, wherein the audio data correspond to speech input received at the mobile communications device;
processing the audio data to generate text;
sending data related to the text from the server computing device to the mobile communications device;
receiving one or more commands based on the data from the mobile communications device via the mobile communications network; and
sending control signals based on the one or more commands to a media controller, wherein the control signals cause the media controller to control multimedia content displayed via a display device.

15. The method of claim 14, further comprising accessing account data associated with the mobile communications device and selecting the media controller from a plurality of media controllers accessible by the server computing device based on the account data associated with the mobile communications device.

16. The method of claim 14, wherein the media controller comprises a set-top box device coupled to the display device.

17. The method of claim 14, wherein the audio data is received from the mobile communications device via hypertext transfer protocol (HTTP).

18. The method of claim 14, wherein the control signals are sent to the media controller via hypertext transfer protocol (HTTP).

19. The method of claim 14, wherein processing the audio data to generate the text comprises comparing the speech input to a media controller grammar and determining the text based on the media controller grammar and the audio data.

20. A mobile communications device, comprising:
one or more input devices, the one or more input devices including a microphone to receive a speech input;
a display;
a processor; and
memory accessible to the processor, the memory including processor-executable instructions that, when executed, cause the processor to:
generate audio data based on the speech input;
send the audio data via a mobile data network to a first server, wherein the first server processes the audio data to generate text based on the speech input;
receive data related to the text from the first server;
generate a graphical user interface at the display based on the received data;
receive input via the graphical user interface using the one or more input devices;
generate one or more commands based at least partially on the received data in response to the input; and
send the one or more commands to a second server via the mobile data network, wherein, in response to the one or more commands, the second server sends control signals to a media controller, wherein the control signals cause the media controller to control multimedia content displayed via a display device.
